(19) United States
(12) Patent Application Publication
(10) Pub. No.: US 2012/0101649 A1
(43) Pub. Date: Apr. 26, 2012

(54) METHOD AND SYSTEM FOR DETERMINING ARTICLE OF COMMERCE ENERGY CONSUMPTION USING IDENTIFICATION INDICIA

(75) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/338,865

(22) Filed: Dec. 28, 2011

(51) Int. Cl. G05D 11/00

(52) U.S. Cl. 700/291

(57) ABSTRACT

Embodiments of the present invention provide a method, system and apparatus for obtaining energy consumption data associated with an article of commerce. Identification indicia associated with an article of commerce is received. The identification indicia is transmitted and, in response to transmitting the identification indicia, energy consumption data is received and displayed. The energy consumption data is associated with the article of commerce.

### CROSS-REFERENCE TO RELATED APPLICATION

n/a

STATEMENT REGARDING FEDERALLY SPONSORED RESEARCH OR DEVELOPMENT

n/a

### FIELD OF THE INVENTION

The present invention relates to energy consumption, and in particular to a method and system for obtaining energy consumption data of an article of commerce based on identification indicia associated with the article of commerce.

### BACKGROUND OF THE INVENTION

Most of the energy consumed by home appliances is produced by power plants that burn fossil fuel to provide homes with electricity. The burning of fossil fuels releases carbon dioxide into the environment causing environmental problems such as air pollution, acid rain and the greenhouse effect. Given the environmental consequences of producing energy, it is desirable to reduce the demand for energy and use energy more efficiently. One way to reduce the energy consumed by households is to use energy efficient devices such as energy efficient appliances.

To this effect, many appliance manufacturers have developed and market appliances that are energy efficient. Environmentally conscious consumers may minimize the environmental impact of their home by purchasing these environmentally friendly appliances. Environmentally conscious consumers tend to consider not only the price of the appliance, but also the costs of use of the appliance and the effects that their new appliance will have on the environment.

However, determining the energy consumption of an appliance requires a consumer to spend a significant amount of time reading the appliance's manuals or visiting the websites of numerous appliance manufacturers in an attempt to determine and compare energy consumption data. Even if the consumer finds the energy consumption data, the information may be difficult to understand. Additionally, the energy consumption data provided does not give the purchaser the monetary cost associated with the energy consumption of the appliance, since energy costs can vary widely from region to region.

What is needed is a method and system for obtaining the energy consumption of an article of commerce and the cost associated with the energy consumption of the article of commerce.

### SUMMARY OF THE INVENTION

The present invention advantageously provides a method, apparatus and system for obtaining energy consumption data of an article of commerce. In accordance with one aspect, the invention provides a method in which identification indicia associated with an article of commerce is obtained and transmitted. In response to transmitting the identification indicia, energy consumption data associated with the article of commerce is received and displayed.

In accordance with another aspect, the present invention provides an apparatus that has an input device, a transmitter, a receiver and a display. The input device receives identification indicia associated with an article of commerce. The transmitter transmits the identification indicia, and a receiver receives energy consumption data associated with the article of commerce. The display displays the energy consumption data.

According to another aspect, the invention provides a system that includes a server having a receiver for receiving identification indicia associated with an article of commerce. The server also has a memory that stores an energy consumption database. The energy consumption database includes energy consumption data associated with the article of commerce. A transmitter transmits the energy consumption data.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an exemplary system for determining energy consumption data of an article of commerce, constructed in accordance with the principles of the present invention;

FIG. 2 is a block diagram of an exemplary device constructed in accordance with the principles of the present invention;

FIG. 3 is a block diagram of an exemplary apparatus constructed in accordance with the principles of the present invention;

FIG. 4 is a block diagram of an exemplary server constructed in accordance with the principles of the present invention;

FIG. 5 is a block diagram of an exemplary energy consumption database constructed in accordance with the principles of the present invention;

FIG. 6 is a block diagram of an exemplary merchant computer constructed in accordance with the principles of the present invention; and

FIG. 7 is a flow chart of an exemplary process for obtaining energy consumption data of an article of commerce, in accordance with the principles of the present invention.

### DETAILED DESCRIPTION OF THE INVENTION

Embodiments of the present invention provide a system, a method and an apparatus for obtaining energy consumption data associated with an article of commerce. In accordance with an embodiment of the present invention, identification indicia associated with an article of commerce is received. The identification indicia is transmitted and, in response to transmitting the identification indicia, energy consumption data associated with the article of commerce is received and displayed.

Before describing in detail exemplary embodiments that are in accordance with the present invention, it is noted that the embodiments reside primarily in combinations of apparatus components and processing steps related to implementing a method, system and an apparatus for determining energy consumption data associated with an article of commerce. Accordingly, the system, method and apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

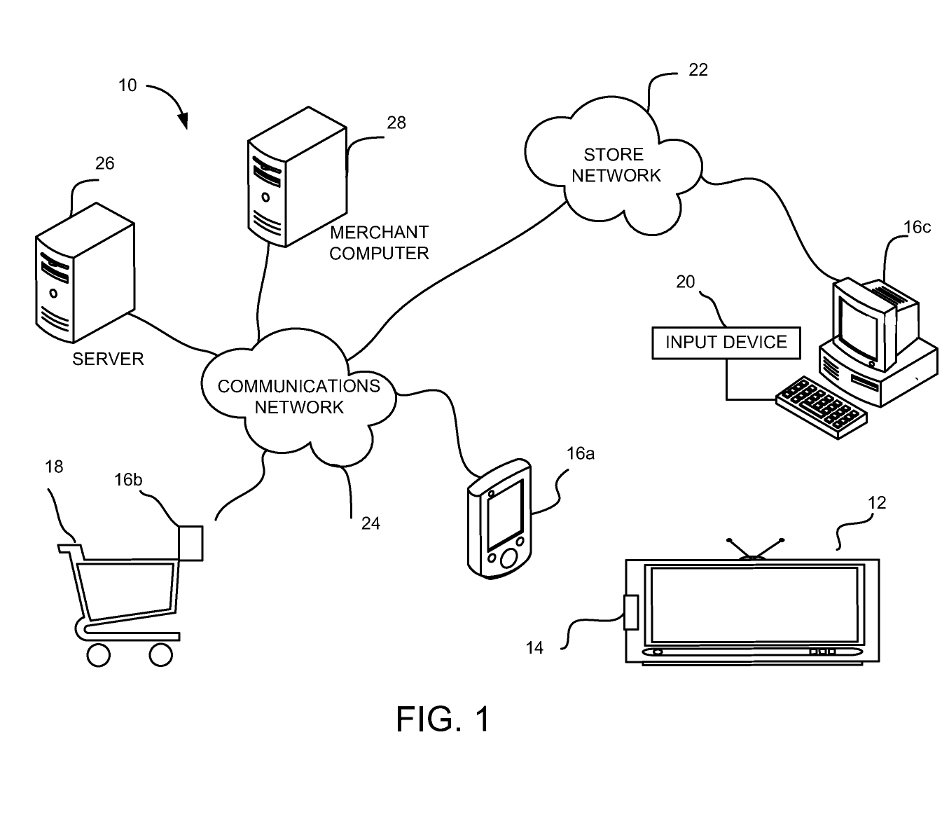

Referring now to the drawing figures in which reference designators refer to like elements, there is shown in FIG. 1 a diagram of an exemplary system constructed in accordance with the principles of the present invention and designated generally as “10”. System 10 may obtain energy consumption data associated with article of commerce 12. Article of commerce 12 may be any device that consumes energy, such as a television, a video game console, a computer, an appliance, a stereo, an amplifier, powered speakers, etc.

Article of commerce 12 is associated with identification indicia 14. To obtain the energy consumption of article of commerce 12, identification indicia 14 may be scanned using wireless mobile device 16a or device 16b positionable on shopping cart 18. Identification indicia 14 may also be scanned by input device 20, which may be a scanner attached to apparatus 16c. Apparatus 16c may be located at a merchant store and may be in communication with store network 22 and communications network 24. Wireless mobile device 16a, device 16b, and apparatus 16c are referred collectively herein as identification indicia input device (IIID) 16.

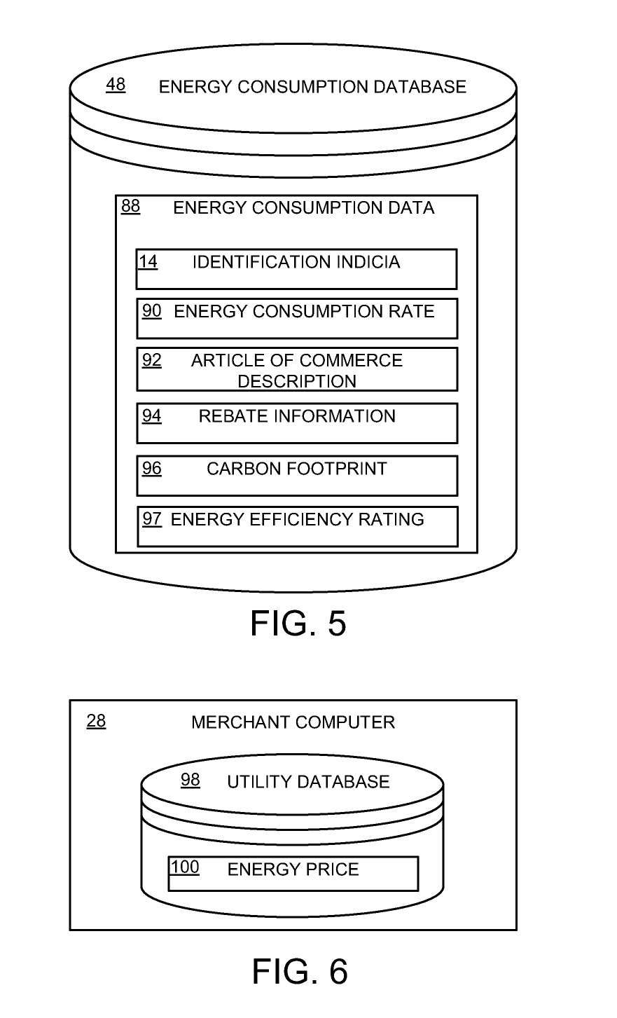

IIID 16 transmits identification indicia 14 to server 26 via communications network 24. In response to receiving identification indicia 14, server 26 transmits to IIID 16 energy consumption data 88 associated with article of commerce 12. Energy consumption data 88 is further discussed in FIG. 5. Server 26 and IIID 16 may be connected to merchant computer 28. Merchant computer 28 may send energy price 100 information to server 26 or IIID 16. Energy price 100 is further discussed in FIG. 6.

Identification indicia 14 may be a barcode, or any other machine-readable representation of data. Identification indicia 14 may be a one dimensional code, a two dimensional code, a multi-dimensional code, a numeric code, a code word, a geometric code, a linear barcode, a matrix barcode, a two dimensional data matrix, an image, or combinations thereof. Identification indicia 14 may include digits, characters, symbols, images, or a digital signature. In an exemplary embodiment, special position detection patterns embedded in identification indicia 14 facilitate reading of identification indicia 14.

Identification indicia 14 may be included in a tag attached to article of commerce 12, or may be a part of article of commerce 12. For example, identification indicia 14 may be printed to a box containing article of commerce 12 or may be attached to article of commerce 12 by adhesive labels or any other suitable manner. In one embodiment, identification indicia 14 may be an image of article of commerce 12 captured with wireless mobile device 16a.

Wireless mobile device 16a may be a smart phone, a computer tablet, a cell phone, a laptop computer, a wireless device, a personal information device, a personal digital assistant, or any device capable of communication with another electronic device. Wireless mobile device 16a may communicate with server 26 and merchant computer 28 via communications network 24 wirelessly or by wire or optical fiber. For example, wireless mobile device 16a may communicate with communications network 24 using Orthogonal Frequency Division Multiplex (OFDM), Code Division Multiple Access (CDMA), Wi-Fi, WiMax, Near Field Communication, or other wireless LAN and/or cellular technology.

Communications network 24 and store network 22 may include a cellular communications network, a Public Switched Telephone Network (PSTN), or other wide area network (WAN), such as the Internet, as well as local area networks (LANs), such as an Ethernet LAN. Communications network 24 and store network 22 may be a wireless network, such as Wi-Fi, WiMax, satellite, infrared, Bluetooth, Near Field Communications, or other communications network.

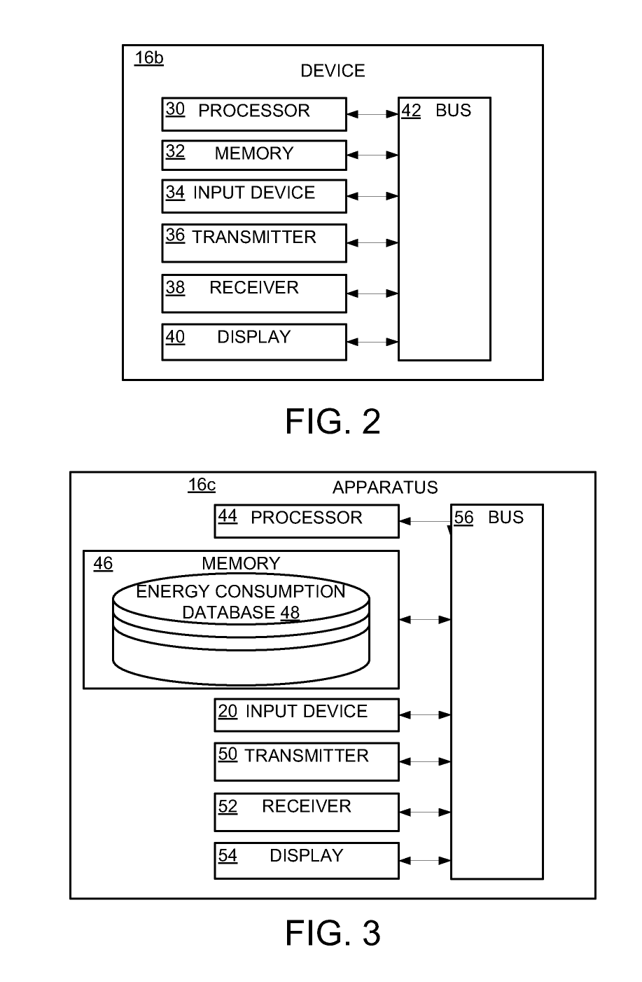

FIG. 2 is a block diagram of an exemplary device 16b, constructed in accordance with the principles of the present invention. Device 16b may be a computer, a computer tablet, a wireless device, or any computing device capable of performing the functions described herein. Device 16b may be a portable device positionable on, for example, shopping cart 18, a shopping basket, a customer's shopping bag, etc. Device 16b includes processor 30 in communication with memory 32, input device 34, transmitter 36, receiver 38 and display 40 via communication infrastructure/bus 42. Of note, the elements described herein with respect to device 16b are equally applicable to exemplary elements of wireless device 16a.

Processor 30 may include a central processing unit (CPU) for performing device 16b functionality. Input device 34 may be a keyboard, a key pad, or a scanner. Device 16b may use transmitter 36 and receiver 38 for communicating with server 26 and merchant computer 28 via communications network 24 wirelessly or by wire or optical fiber. Display 40 may be a liquid crystal display (LCD), light-emitting diode (LED) display, touch screen display, among other types of displays. In an exemplary embodiment, display 40 may face toward the rear of a shopping cart in order for a customer, who is pushing the cart, to readily see data as it is being displayed on the display unit.

FIG. 3 is a block diagram of an exemplary apparatus 16c, constructed in accordance with the principles of the present invention. Apparatus 16c may be a laptop, a desktop computer, or any computing device located at a merchant store. For example, apparatus 16c may be located next to a price check computer at a merchant store. Apparatus 16c includes processor 44, memory 46, input device 20, transmitter 50, receiver 52, display 54 and communication interface/bus 56 that function substantially the same as the corresponding device 16b components, with size and performance being adjusted based on design requirements. Apparatus 16c is in communication with server 26 and merchant computer 28 via communication network 24. Store network 22 connects apparatus 16c to communications network 24. Memory 32 may include energy consumption database 48, among other databases. Energy consumption database 48 is further discussed below with reference to FIG. 5.

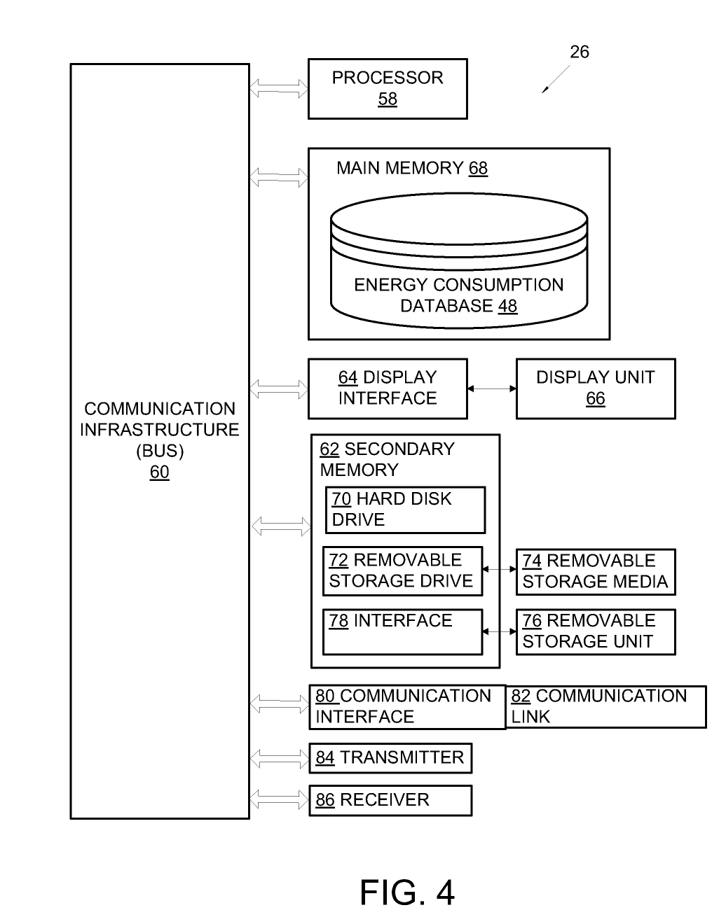

FIG. 4 is a block diagram of an exemplary server 26 constructed in accordance with the principles of the present invention. Server 26 includes one or more processors, such as processor 58 programmed to perform the functions described herein. Processor 58 is operatively coupled to a communication infrastructure 60, e.g., a communications bus, cross-bar interconnect, network, etc. Processor 58 may execute computer programs stored on disk storage for execution via secondary memory 62. Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of server 26 may be designed to occur remotely by web browser. In such case, the inclusion of a display interface and display unit may not be required.

Server 26 may optionally include or share a display interface 64 that forwards graphics, text, and other data from the communication infrastructure 60 (or from a frame buffer not shown) for display on the display unit 66. Display unit 66 may be a cathode ray tube (CRT) display, liquid crystal display (LCD), light-emitting diode (LED) display, touch screen display, among other types of displays. The computer system also includes a main memory 68, such as random access memory (“RAM”) and read only memory (“ROM”). Memory 68 may store energy consumption database 48. Secondary memory 62 may include, for example, a hard disk drive 70 and/or a removable storage drive 72, representing a removable hard disk drive, magnetic tape drive, an optical disk drive, etc. The removable storage drive 72 reads from and/or writes to a removable storage media 74 in a manner well known to those having ordinary skill in the art. Removable storage media 74, represents, for example, a floppy disk, external hard disk, magnetic tape, optical disk, etc. which is read by and written to by removable storage drive 72. As will be appreciated, the removable storage media 74 includes a computer usable storage medium having stored therein computer software and/or data.

In alternative embodiments, secondary memory 62 may include other similar devices for allowing computer programs or other instructions to be loaded into the computer system and for storing data. Such devices may include, for example, a removable storage unit 76 and an interface 78. Examples of such may include a program cartridge and cartridge interface (such as that found in video game devices), flash memory, a removable memory chip (such as an EPROM, EEPROM or PROM) and associated socket, and other removable storage units 76 and interfaces 78 which allow software and data to be transferred from the removable storage unit 76 to other devices.

Server 26 may also include a communication interface 80. Communication interface 80 allows software and data to be transferred to external devices. Examples of communications interface 80 may include a modem, a network interface (such as an Ethernet card), a communications port, a PCMCIA slot and card, wireless transceiver/antenna, etc. Software and data transferred via communications interface/module 80 may be, for example, electronic, electromagnetic, optical, or other signals capable of being received by communications interface 80. These signals are provided to communication interface 80 via the communication link (i.e., channel) 82. Channel 82 carries signals and may be implemented using wire or cable, fiber optics, a phone line, a cellular phone link, an RF link, and/or other communications channels.

It is understood that server 26 may have more than one set of communication interface 80 and communication link 82. For example, server 26 may have a communication interface 80/communication link 82 pair to establish a communication zone for wireless communication, a second communication interface 80/communication link 82 pair for low speed, e.g., WLAN, wireless communication, another communication interface 80/communication link 82 pair for communication with low speed wireless networks, and still another communication interface 80/communication link 82 pair for other communication.

Computer programs (also called computer control logic) are stored in main memory 68 and/or secondary memory 62. For example, computer programs are stored on disk storage, i.e. secondary memory 62, for execution by processor 58 via RAM, i.e. main memory 68. Computer programs may also be received via communication interface 80. Such computer programs, when executed, enable the method and system to perform the features of the present invention as discussed herein. In particular, the computer programs, when executed, enable processor 58 to perform the features of the corresponding method and system. Accordingly, such computer programs represent controllers of the corresponding device. Server 26 also includes transmitter 84 and receiver 86. Processor 58 communicates with transmitter 84 and receiver 86 via communication infrastructure 60. Server 26 may be in communication with IIID 16 and merchant computer 28 via communications network 24.

FIG. 5 is a block diagram of exemplary energy consumption database 48 according to the principles of the present invention. Energy consumption database 48 may include energy consumption data 88 corresponding to article of commerce 12. Energy consumption data 88 may include at least one of identification indicia 14 associated with article of commerce 12, an energy consumption rate 90 of article of commerce 12, article of commerce description 92, rebate information 94, carbon footprint 96 and energy efficiency rating 97. Energy consumption rate 90 may include the power, e.g., Watts, consumed by article of commerce 12 per unit of time. Article of commerce description 92 may include a description of article of commerce 12, such as for example the make and model of article of commerce 12, features of article of commerce 12, and a price of article of commerce 12. Rebate information 94 may include information such as, whether the purchase of article of commerce 12 entitles the customer to some kind of rebate, like a manufacturer rebate or a rebate issued by the government, including an energy rebate. Some rebates may encourage the customer to purchase article of commerce 12 by, for example, offering the customer the option to buy the appliance tax free. Rebates may also offer the customer cash back or a deduction in their electricity bills or income tax.

Carbon footprint 96 may include information about environmental pollution caused directly or indirectly by article of commerce 12, such as an amount of fossil fuel that must be burned to supply energy to article of commerce 12 or an amount of carbon dioxide emitted by article of commerce 12. Additionally, carbon footprint 96 may include a toxicity rating associated with article of commerce 12. The toxicity rating may depend on the type of power plant producing the energy consumed by article of commerce 12, including but not limited to a coal-fired power plant, a natural gas power plant, a biomass power plant fueled by waste from sugar cane, municipal waste or other forms of biomass, a solar thermal power plant, etc. For example, if article of commerce 12 consumes energy produced by a nuclear power plant, the toxicity rating may be high, while if the energy was produced by a hydroelectric power plant, the toxicity rating may be low.

FIG. 6 is a block diagram of an exemplary merchant computer 28 constructed in accordance with the principles of the present invention. Merchant computer 28 may be a laptop, a desktop computer, a server computer, a portable computing device, or any computing device capable of communicating with another computing device. Merchant computer 28 may be in communication with server 26 and IIID 16 via communications network 24. Merchant computer may be associated with a government agency, a power utility company, a private organization, or any third party. Merchant computer 28 may include utility database 98. Utility database 98 may contain utility price information associated with article of commerce 12. For example, utility database 48 may include energy price 100. Energy price 100 may depend on energy consumption rate 90 of article of commerce 12. For example, energy price 100 may depend on the power consumed by article of commerce 12 times the approximate number of hours per day that the average consumer uses article of commerce 12. Energy price 100 may vary depending on the location of the energy consumption. For example, energy price 100 may be higher in a large city and lower in a small town. Merchant computer 28 may send energy price 100 to IIID 16 or server 26

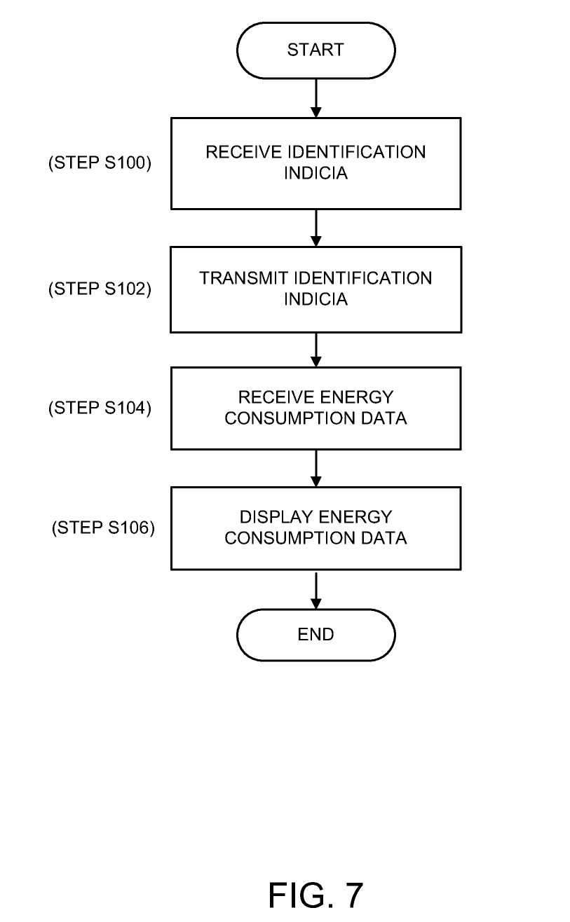

FIG. 7 is a flow chart of an exemplary process for obtaining energy consumption data of an article of commerce, in accordance with the principles of the present invention IIID 16 may receive, read or scan identification indicia 14 (Step S100), and transmit identification indicia 14 to server 26 (Step S102). Server 26 may query energy consumption database 48 and retrieve energy consumption data 88 associated with identification indicia 14. Server 26 transmits energy consumption data 88 to IIID 16 IIID 16 receives energy consumption data 88 (Step S104) and displays energy consumption data 88 (Step S106).

In an exemplary embodiment, wireless mobile device 16a reads, receives or scans identification indicia 14 associated with article of commerce 12 (Step S100). Wireless mobile device 16a transmits identification indicia 14 to server 26 (Step S102). Receiver 86 of server 26 receives identification indicia 14 transmitted by wireless mobile device 16a. Processor 58 queries energy consumption database 48 for energy consumption data 88 associated with identification indicia 14. Transmitter 84 transmits energy consumption data 88 to wireless mobile device 16a. For example, transmitter 84 may transmit energy consumption rate 90 to wireless mobile device 16a. Wireless mobile device 16a may receive (Step S104) energy consumption data 88 and display energy consumption data 88 (Step S106).

In another exemplary embodiment, wireless mobile device 16a is a self-contained unit in that wireless mobile device 16a includes local storage memory, a charged coupled device (CCD) imaging array and/or a barcode reader, and also a database having a lookup table to identify the article of commerce based on the image of the article of commerce and/or the barcode. In this embodiment, wireless mobile device 16a stores corresponding energy consumption data for articles of commerce as discussed above, e.g., energy consumption rate, energy efficiency, etc., in the storage memory. In this embodiment, wireless mobile device 16a need not include a transmission module, but rather operates to scan the article of commerce (or barcode) and then uses a processor to identify the article of commerce using the local storage. The energy information is then displayed to the user on the display of wireless mobile device 16a.

In another exemplary embodiment, a customer may use device 16b positioned on shopping cart 18 to obtain energy consumption data 88 associated with article of commerce 12. Input device 34 reads, receives or scans identification indicia 14 (Step S100). Input device 34 may be configured to automatically scan identification indicia 14 when article of commerce 12 is added to the shopping cart. Transmitter 36 may transmit identification indicia 14 to server 26 (Step S102). Receiver 86 of server 26 receives identification indicia 14. Processor 58 queries energy consumption database 48 for energy consumption data 88 associated with identification indicia 14. Transmitter 84 transmits energy consumption data 88 to device 16b. Receiver 38 receives (Step S104) energy consumption data 88 and display 40 displays energy consumption data 88 (Step S106).

In another exemplary embodiment, a customer may use apparatus 16c to obtain energy consumption data 88 associated with article of commerce 12. Apparatus 16c may be similar to price check stations found in retail stores. Apparatus 16c includes input device 20 that reads, receives or scans identification indicia 14. Input device 20 may be, for example, a scanner configured to scan identification indicia 14. Transmitter 50 may transmit identification indicia 14 to server 26. Receiver 86 of server 26 receives identification indicia 14. Processor 58 queries energy consumption database 48 for energy consumption data 88 associated with identification indicia 14. Transmitter 84 transmits energy consumption data 88 to apparatus 16c. Receiver 52 receives (Step S104) energy consumption data 88 and display 54 displays energy consumption data 88 (Step S106).

In one exemplary embodiment, IIID 16 includes energy consumption database 48. In this embodiment, IIID 16 does not send identification indicia 14 to server 26 so that server 26 may transmit energy consumption data 88 to IIID 16. Instead, a computer program executed by the IIID 16 queries energy consumption database 48 to obtain and display energy consumption data 88.

In another exemplary embodiment, a customer may wish to know energy consumption data 88 for multiple articles of commerce. For example, a customer may wish to buy multiple articles of commerce, such as an entertainment system including a television, powered speakers, a DVD, and a game station IIID 16 may scan a plurality of identification indicia 14 corresponding to the plurality of articles of commerce IIID 16 may send the identification indicia 14 to server 26. Server 26 may send to IIID 16 energy consumption data 88 corresponding to the plurality of articles of commerce. In another embodiment, energy consumption data 88 can be stored in IIID 16, so that IIID 16 need not download energy consumption data 88 from server 26.

Additionally, server 26 may send total energy consumption data to IIID 16. The total energy consumption data may include the total energy consumed by the multiple articles of commerce. For example, IIID 16 may receive a total energy consumed by the entertainment system as a whole, i.e. the total energy consumed by the television, speakers, DVD and game station. Server 26 or merchant computer 28 may send to IIID 16 a total energy price associated with the total energy consumed by the plurality of articles of commerce.

In another exemplary embodiment, IIID 16 or server 26 may transmit identification indicia 14 to merchant computer 28. Merchant computer 28 may query utility database 98 and transmit energy price 100 to server 26. Server 26 may transmit to IIID 16 energy consumption data 88 including energy price 100. Merchant computer 28 may also transmit energy price 100 to IIID 16. Energy price 100 may be based on the typical energy consumption rate 90 of article of commerce 12. Energy price 100 may also be based on the amount of energy consumed by article of commerce 12 when article of commerce 12 is in an idle mode, i.e., the amount of energy that article of commerce 12 consumes while being plugged in but switched off.

In another exemplary embodiment, a customer may use IIID 16 to enter and send information to merchant computer 28 or server 26, such as an approximate number of hours per day that the customer expects to use article of commerce 12. Merchant computer 28 or server 26 may use the information to calculate energy price 100. Further, energy price 100 may be calculated by considering the time of day that article of commerce 12 will be operational. For example, during high demand, energy price 98 may be higher than during low demand.

In another exemplary embodiment, merchant computer 28 or server 26 may determine one or more articles of commerce that can be suggested to the customer. Merchant computer 28 or server 26 may search energy consumption database 48 for a suggested article of commerce that may complement article of commerce 12. For example, the customer may use IIID 16 to scan identification indicia 14 associated with a stereo system. Merchant computer 28 or server 26 may receive identification indicia 14 and suggest a suggested article of commerce that may complement the stereo system, such as an equalizer, woofer or a set of powered speakers. Merchant computer 28 or server 26 may send to IIID 16 energy consumption data 88 associated with the suggested article of commerce IIID 16 may receive and display energy consumption data 88 associated with the suggested article of commerce. Merchant computer 28 or server 26 may also suggest alternative articles of commerce having better, i.e., more efficient, energy ratings.

In another exemplary embodiment, server 26 may store a customer profile associated with a customer. The customer profile may include information such as, a customer identification, a list of articles of commerce previously purchased by the customer and the customer's energy preferences/requirements for articles of commerce. Server 26 may consider at least one of the customer profile and identification indicia 14 to determine which articles of commerce may be suggested to the customer for purchase.

In another exemplary embodiment, a customer may use IIID 16 to send energy values to server 26 that conform to the customer's preferences/requirements, so that server 26 may suggest articles of commerce that perform as per the energy values. For example, a customer may wish to purchase a television, but may decide that the energy consumption rate 90 associated with the television is not within the customer's preferences/requirements. The customer may then use IIID 16 to enter energy values that conform to the customer's preferences/requirements. IIID 16 sends the energy values to server 26. Server 26 receives the energy values and determines one or more articles of commerce that operate within the customer's preferences/requirements. Server 26 may send energy consumption data 88 associated with the determined one or more articles of commerce to IIID 16.

In another exemplary embodiment, IIID 16 may display a comparison of energy consumption data 88 for different articles of commerce IIID 16 may receive a first and a second identification indicia 14 associated with corresponding first and second articles of commerce 12. IIID 16 may transmit the first and second identification indicia to server 16. Server 26 may send to IIID 16 first and second energy consumption data 88 associated with first and second identification indicia 14, respectively IIID 16 may display a comparison of first and second energy consumption data 88.

The present invention can be realized in hardware, software, or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method, comprising:
receiving first identification indicia associated with a first article of commerce;
transmitting the first identification indicia;
receiving first energy consumption data in response to transmitting the first identification indicia, the first energy consumption data associated with the first article of commerce; and
displaying the first energy consumption data.

2. The method of claim 1, wherein the first identification indicia is an image of the first article of commerce.

3. The method of claim 1, wherein the first identification indicia is a computer readable code.

4. The method of claim 1, wherein the first energy consumption data includes at least one of:
a first energy consumption rate associated with the first article of commerce; and
a first energy price associated with the first energy consumption rate.

5. The method of claim 1, wherein the first energy consumption data includes at least one of a carbon footprint, rebate information and article of commerce description.

6. The method of claim 1, wherein displaying the first energy consumption data includes displaying the first energy consumption data using one of a mobile wireless device, an apparatus located at a merchant store, and a device coupled to a shopping cart.

7. The method of claim 1, further comprising:
receiving suggested article of commerce data, wherein the suggested article of commerce data corresponds to a suggested article of commerce associated with the first article of commerce; and
displaying the suggested article of commerce data.

8. The method of claim 1, further comprising:
receiving second energy consumption data associated with a second article of commerce; and
displaying a total energy consumption data, the total energy consumption data including the first energy consumption data and the second energy consumption data.

9. An apparatus, comprising:
an input device, the input device receiving first identification indicia associated with a first article of commerce;
a transmitter in communication with the input device, the transmitter transmitting the first identification indicia;
a receiver in communication with the transmitter, the receiver receiving first energy consumption data in response to the transmitter transmitting the first identification indicia, the first energy consumption data associated with the first article of commerce; and
a display in communication with the receiver, the display displaying the first energy consumption data.

10. The apparatus of claim 9, wherein the first identification indicia is an image of the first article of commerce.

11. The apparatus of claim 9, wherein the first identification indicia is a computer readable code.

12. The apparatus of claim 9, wherein the first energy consumption data includes at least one of:
a first energy consumption rate associated with the first article of commerce; and
a first energy price associated with the first energy consumption rate.

13. The apparatus of claim 9, wherein the first energy consumption data includes at least one of a carbon footprint, rebate information and article of commerce description.

14. The apparatus of claim 9, wherein the receiver further receives second energy consumption data associated with a second article of commerce; and
the display further displays a total energy consumption data, the total energy consumption data including the first energy consumption data and the second energy consumption data.

15. A system, comprising:
a server, the server including:
a receiver, the receiver receiving first identification indicia associated with a first article of commerce;
a memory in communication with the receiver, the memory storing an energy consumption database including first energy consumption data associated with the first article of commerce; and
a transmitter in communication with the memory, the transmitter transmitting the first energy consumption data in response to the receiver receiving the first identification indicia.

16. The system of claim 15, wherein the first identification indicia is a computer readable code.

17. The system of claim 15, wherein the first energy consumption data includes at least one of:
a first energy consumption rate associated with the first article of commerce; and
a first energy price associated with the first energy consumption rate.

18. The system of claim 15, further comprising a merchant computer, the merchant computer comprising a memory storing a utility database, the utility database including an energy price, and wherein the energy price and energy consumption data are usable to determine a cost of operating the first article of commerce.

19. The system of claim 15, wherein transmitting the first energy consumption data includes transmitting the first energy consumption data to one of a mobile wireless device, a merchant computer and a device coupled to a shopping cart.

20. The system of claim 15, wherein the transmitter further transmits:
second energy consumption data associated with a second article of commerce; and
total energy consumption data, the total energy consumption data including the first energy consumption data and the second energy consumption data.
